(19) United States
(12) Patent Application Publication
(10) Pub. No.: US 2004/0098555 A1
(43) Pub. Date: May 20, 2004

(54) Method for dynamic memory management

(76) Inventors: Michael Beuten, Schwieberdingen (DE); Klaus Schneider, Ludwigsburg (DE); Matthias Knauss, Schorndorf (DE); Peter Poinstingl, Zwettl (AT)

Correspondence Address: KENYON & KENYON, ONE BROADWAY, NEW YORK, NY, 10004, US

(21) Appl. No.: 10/633,113

(22) Filed: Aug. 1, 2003

(30) Foreign Application Priority Data
Aug. 2, 2002 (DE) 102 35 380.8

(51) Int. Cl. G06F 12/00

(52) U.S. Cl. 711/170; 713/1

(57) ABSTRACT

A method for providing dynamic memory management, and a memory device and a system for implementing this method. In addition, a computer program and a computer program product. The memory device includes a first memory block, in which a startup program is stored, and a number of additional memory blocks. The first memory block and the additional memory blocks are connected by a chained list, which is executed at the time of checking of the memory device. The startup program obtains data necessary for a check from the memory blocks themselves.

### FIELD OF THE INVENTION

The present invention relates to a method for dynamic memory management as well as a memory device and a system for the execution of this method. Furthermore, the present invention relates to a computer program and a computer program product.

### BACKGROUND INFORMATION

Microcontrollers used in control units may be equipped with non-volatile memory devices, in which the functions necessary for control are stored as program code. A start program or startup code may be included in the memory device, which is stored in a boot area or BIOS (Basic Input/Output System) and which contains the program instructions necessary when booting up the microcontroller.

The memory device thus includes a boot area and a number of functions or applications.

The functions stored in the memory device may be checked starting from the boot block as part of memory management. This occurs, for instance, upon booting the microcontroller, in order to guarantee a flawless operation of the control unit.

Checking occurs here by using available algorithms like, for example, a checksum or by a cyclic block backup using a CAC (cyclic redundancy check) checksum. The remaining memory may be divided into logical memory blocks. A single check always occurs via a logical memory block, the memory layout being predetermined in the boot block.

Since the layout of the remaining memory is recorded in the boot block, a change in the memory layout results inevitably in a change in the boot block. Hence the boot block may not be safely exchangeable.

### SUMMARY OF THE INVENTION

In the method of dynamic memory management of a memory device according to the present invention the memory device including a first memory block, in which a startup program is stored, and a number of additional memory blocks, and where the first memory block and the additional memory blocks are connected by a chained list when checking the memory device it is intended for the chained list to be executed and for the startup program to obtain data necessary for a check directly from the memory blocks.

Within a chained list a reference to the next memory block is stored in each memory block. The method according to the present invention hereby facilitates a flexible dynamic memory management. A change in size and position of the memory blocks has no effect on the boot block. Moreover, memory blocks are also individually exchangeable.

The present invention facilitates a dynamic memory management without changing the startup code. This is achieved by partitioning the memory and introducing a chained list. The startup code obtains the information on the blocks to be checked not from a list in the startup code, but from the blocks. Memory blocks are thus appendable to the system without a problem, since each block also contains logistical information.

The check is performable using a checksum or a cyclic block backup, i.e., via a CAC checksum.

The check is executable at the time of system boot or also in the background during normal system operation. The check ensures the data integrity of the memory device.

The memory device according to the present invention includes a first memory block, in which a startup program is stored, and a number of additional memory blocks. The first memory block and the additional memory blocks are connected by a chained list and each of the additional memory blocks contains data necessary for a check.

In the exemplary embodiment of the present invention each of the additional memory blocks includes an information area, in which information on the memory block itself is stored, and a checking area, in which information for performing the check is stored.

The system according to the present invention includes a computing unit and a memory device. The memory device contains a first memory block, in which a startup program is stored, and a number of additional memory blocks. The first memory block and the additional memory blocks are connected by a chained list. Each of the additional memory blocks contains data necessary for a check.

A non-volatile memory module may be used as the memory device. EPROMs and flash memory modules lend themselves as nonvolatile rewritable memory devices, for example.

An embedded microcontroller may be provided as the computing unit.

According to the present invention the computer program includes program code for executing the steps of the abovedescribed method and will be executed on a computer or an appropriate computing unit.

The computer program product is stored on a computer-readable medium. EEPROMs and flash memories, but also CD-ROMs, floppy disks, as well as hard disk drives, are used as suitable media.

### BRIEF DESCRIPTION OF THE DRAWINGS

FIG. 1 shows an exemplary embodiment of the system according to the present invention in a diagram.

FIG. 2 shows the structure of an exemplary embodiment of the memory device according to the present invention.

FIG. 3 schematically shows the structure of memory blocks stored in a memory device according to the present invention.

FIG. 4 illustrates in a schematic diagram the concept of a chained list.

### DETAILED DESCRIPTION

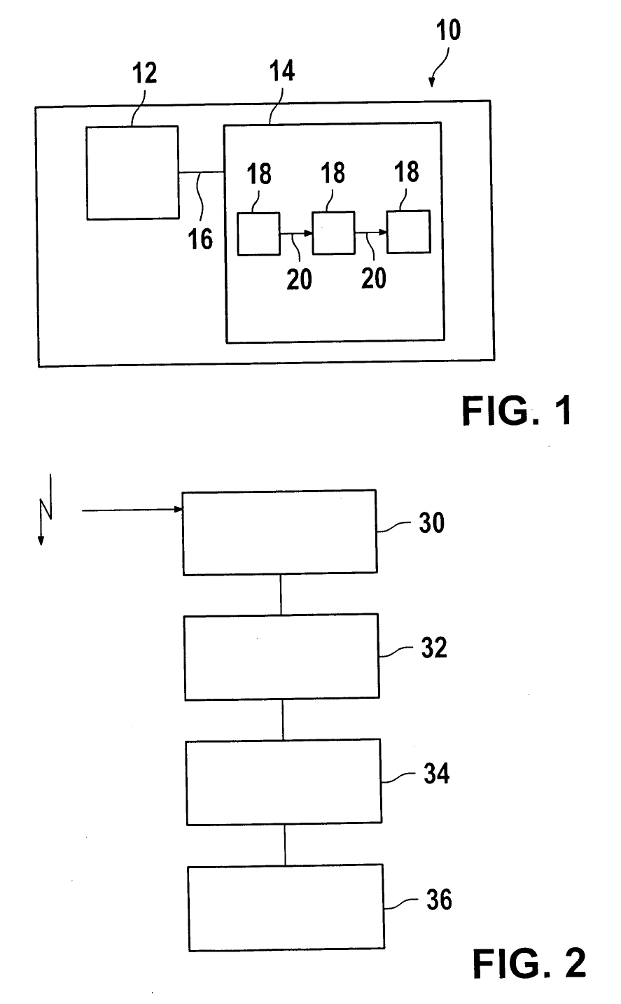

In FIG. 1 a system according to the present invention is represented overall with the reference number 10. It includes an electronic computing unit 12 and a memory device 14, in this case an EPROM. Computing unit 12 and memory device 14 are connected with each other by a data line 16, so that computing unit 12 has access to the data stored in memory device 14.

Storage unit 14 contains three memory blocks 18. These memory blocks 18 contain functions or applications.

As illustrated by arrows 20, memory blocks 18 are stored as a chained list. This means that a reference to next memory block 18 arranged in the sequence of the chained list is always stored in each memory block 18. Merely the last memory block 18 in the list has an identifier referring to the end of the chained list.

Memory blocks 18 each contain data or information, which facilitate a check or testing of the respective block.

Memory blocks 18 stored in memory device 14 are basically always current. The chained list is implemented, in order to build up a variable memory structure, which may allow for a flexible dynamic memory management.

In FIG. 2 the structure of a memory device according to the present invention is depicted. A first memory block, boot block 30, contains the startup code, which controls the booting of the entire system, for example after a reset. The startup code is typically project-independent. Only a few changes are performed in the course of the development. Thereby a high degree of stability is provided.

A second block, protected area block 32 (the memory block for the protected area), contains project-dependent data, which is supposed to be changed only a little and is therefore especially protected.

In a third block, application block 34, an application program is stored. This is subject to frequent changes in the course of the development. This block 34 may be replaced without having to modify or even replace boot block 30.

A fourth block, data block 36, contains the application data necessary to operate the entire system, which has to be changed frequently both during development and during the subsequent operation.

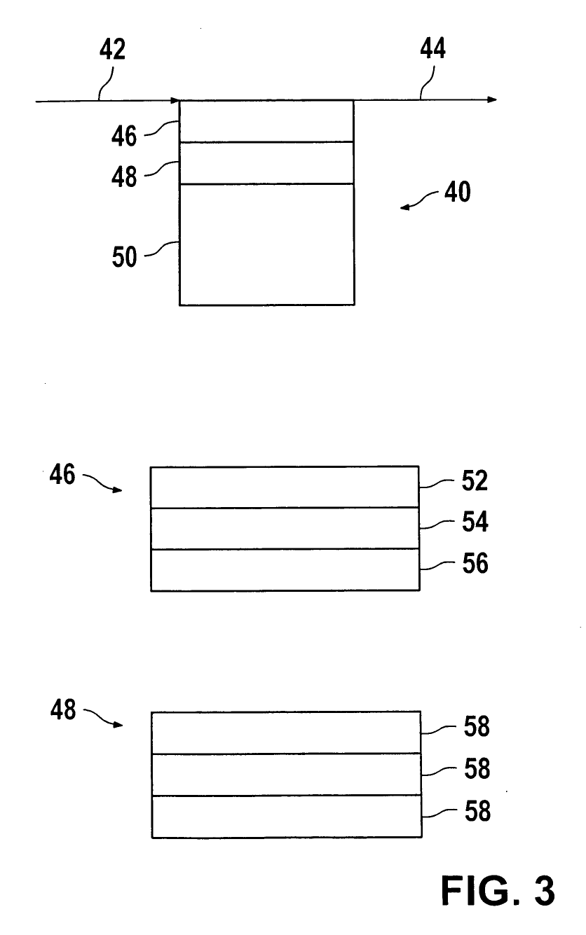

FIG. 3 shows the structure of a memory block 40 as an example. A pointer 42 illustrates the referencing of this block 40 by a preceding memory block in the chained list. A pointer 44 points to the next block in the list.

In memory block 40 an information area 46 is provided, in which information on the memory block 40 itself, such as for example an identifier, is stored.

A checking area 48 contains information for performing the check. This information defines the manner this memory block 40 will be checked.

In a third area 50 the payload of memory block 40 is stored.

Information area 46 contains in first section 52 data for identifying memory block 40. A second section 54 contains the reference to the next memory block in the chained list. A third section 56 may contain additional references.

Checking area 48 contains, in several sections 58, checking data for different checking areas.

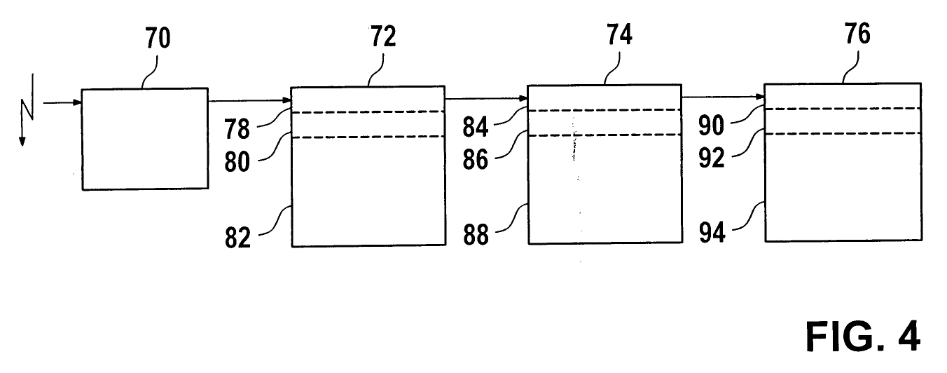

FIG. 4 illustrates the concept of the chained list. A boot block 70, a protected area block 72, an application block 74 and a data block 76 are to be discerned. Blocks 70, 72, 74 and 76 are located in a chained list, meaning that the first three blocks 70, 72 and 74 always point to the next block 72, 74, 76. Merely data block 76 contains an identifier which indicates the end of the chained list.

In boot block 70 the startup code is stored, which at the time of system boot controls the necessary sequences therefor. Protected area block 72 contains an information area 78, a checking area 80 and a protected data area 82. Also application block 74 includes an information area 84, a checking area 86, and a data area 88. The same is true for data block 78, which includes an information area 90, a checking area 92, and a data area 94.

Partitioning the memory and introducing a chained list permits a dynamic memory management without having to change the startup code. The startup code retrieves the information on the blocks to be checked not from a list in the startup code, but from the blocks themselves. Hence blocks are easily appendable to the system, since each block contains the data necessary for a check, as well as logistical information.

Partitioning of the memory facilitates its subdivision into logical blocks. The individual partitions or blocks are exchangeable without the necessity of changing the startup code.

In order not to be able to change the position and size of the blocks easily, they are connected by a chained list. This is executed beginning with the startup code. Each block contains the necessary additional information in an information area and a checking area. Checking or testing ensures data integrity.

The chained list is executed through in a protected manner. The information read is checked before evaluation. So the information in the information area itself, for example, is protected by a checksum algorithm. Information from the information area is used only when its integrity is guaranteed. The same applies to the contents of the checking areas.

What is claimed is:

1. A method for providing dynamic memory management of a memory device, the method comprising:
providing a first memory block in the memory device;
storing a startup program in the first memory block;
providing additional memory blocks; and
connecting the first memory block and the additional memory blocks by a chained list;
wherein the chained list is executed upon checking the memory device and the startup program obtains data for a check from the additional memory blocks.

2. The method of claim 1, wherein the checking is performed using an addition checksum.

3. The method of claim 1, wherein the checking is performed by a cyclic block backup.

4. The method of claim 1, wherein the checking is performed at a time of booting a system that includes the first memory block and the additional memory blocks.

5. The method of claim 1, wherein the checking is performed in the background during operation of a system that includes the first memory block and the additional memory blocks.

6. A memory device, comprising:
a first memory block to store a startup program; and
additional memory blocks to store data for a check;
wherein the first memory block and the additional memory blocks are connected by a chained list.

7. The memory device of claim 6, wherein each of the additional memory blocks includes an information area that stores information on the memory block itself and a checking area that stores information for performing the check.

8. A system, comprising:
a computing unit;
a memory device including a first memory block to store a startup program; and
additional memory blocks to store data for a check;
wherein the first memory block and the additional memory blocks are connected by a chained list.

9. The system of claim 8, wherein the memory device includes a non-volatile memory module.

10. The system of claim 8, wherein the computing unit includes an embedded microcontroller.

11. A computer program including program code for providing dynamic memory management of a memory device, the program code being executable in a computing arrangement to perform the following:
providing a first memory block in the memory device;
storing a startup program in the first memory block;
providing additional memory blocks; and
connecting the first memory block and the additional memory blocks by a chained list;
wherein the chained list is executed upon checking the memory device and the startup program obtains data for a check from the additional memory blocks.

12. A computer-readable storage medium including program code for providing dynamic memory management of a memory device, the program code being executable in a computing arrangement to perform the following:
providing a first memory block in the memory device;
storing a startup program in the first memory block;
providing additional memory blocks; and
connecting the first memory block and the additional memory blocks by a chained list;
wherein the chained list is executed upon checking the memory device and the startup program obtains data for a check from the additional memory blocks.
